(19) United States
(12) Patent Application Publication
(10) Pub. No.: US 2010/0171802 A1
(43) Pub. Date: Jul. 8, 2010

(54) INK CARTRIDGE AND INK CIRCULATION SYSTEM

(75) Inventors: Young-su Lee, Suwon-si (KR); Sung-wook Kang, Seoul (KR); Il-ju Mun, Suwon-si (KR); Myung-song Jung, Gunpo-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/555,848

(22) Filed: Sep. 9, 2009

(30) Foreign Application Priority Data
Jan. 7, 2009 (KR) 10-2009-0001288

(51) Int. Cl. B41J 2/175

(52) U.S. Cl. 347/87

(57) ABSTRACT

An ink cartridge easily attached to and removed from an inkjet printer and an ink circulation system of the inkjet printer. The ink cartridge includes a plurality of print heads ejecting ink, an ink channel unit supplying ink to the plurality of print heads, at least one filter unit filtering ink supplied to the ink channel unit, and at least one septum unit connecting the ink channel unit, at least one filter unit, and the inkjet printer. The ink circulation system includes the ink cartridge, an ink tank storing ink to be supplied to the ink cartridge, at least one 3-way valve interposed between the ink cartridge and the ink tank to selectively control channel circulation and priming circulation, the channel circulation circulating ink in the ink channel unit and the priming circulation circulating ink in the at least one filter unit, and an ink pump interposed between the at least one 3-way valve and the ink tank for providing driving power for circulating ink.

### CROSS-REFERENCE TO RELATED APPLICATIONS

This application claims priority under §119(a) from benefit of Korean Patent Application No. 10-2009-0001288, filed on Jan. 7, 2009, in the Korean Intellectual Property Office, the disclosure of which is incorporated herein in its entirety by reference.

### BACKGROUND

1. Field of the Invention

The present general inventive concept relates to an inkjet printer having a multi-array head, and more particularly, to an ink cartridge and an ink circulation system.

2. Description of the Related Art

In general, inkjet printers are devices for discharging a small amount of droplets of printing ink onto a desired position on a printing medium, such as a piece of paper or a piece of cloth, and printing an image having a predetermined color onto the surface of the printing medium.

A general inkjet printer includes an ink cartridge which moves back and forth in a direction perpendicular to a moving direction of a printing medium, for example, a piece of paper, that is, in a width direction of the piece of paper, and prints an image on the piece of paper. However, such a general inkjet printer having the ink cartridge that moves back and forth and prints an image has low printing speeds.

Currently, an ink cartridge having a plurality of print heads arranged along a width direction of a printing medium, for example, a piece of paper, is implemented so as to develop an inkjet printer capable of printing an image at high speeds without back-and-forth moving of the ink cartridge during a print job. Such an inkjet printer is also denoted as a multi-array head type inkjet printer.

An ink cartridge is detachably installed in a multi-array head type inkjet printer. The multi-array head type inkjet printer includes an ink tank, a filter unit, and a negative pressure adjusting unit. The ink tank stores therein ink to be supplied to the ink cartridge, the filter unit is interposed between the ink tank and the ink cartridge and removes foreign substances contained in ink to be supplied from the ink tank to the ink cartridge, and the negative pressure adjusting unit is connected to the ink tank and provides negative pressure to an ink path so as to prevent leakage of ink. The ink cartridge includes a plurality of print heads having nozzles for discharging ink, an ink channel unit having channels formed therein for supplying ink to the plurality of print heads, and a septum unit connects the ink channel unit and the inkjet printer.

When the ink cartridge is installed in the inkjet printer or is used after being installed in the inkjet printer, air may flow into an ink path of the filter unit and the ink channel unit. When air flowing into the ink path is not removed, a meniscus of the nozzles in the print heads may be broken due to sudden pressure drop by bubble point pressure in the filter unit and thus printing quality may be poor.

Here, when the ink cartridge is distributed while ink or other fillers fill the entire ink path in order to remove influence of the bubble point pressure in the filter unit, ink or the fillers may be leaked due to a change in surroundings and air may flow into the ink path. Thus, a means for preventing leakage of ink or fillers is needed in the ink cartridge and thus a manufacturing cost of the ink cartridge may be increased.

### SUMMARY

The present general inventive concept provides an ink circulation system having an ink cartridge, to which a filter unit is combined, and a 3-way valve so as to selectively circulate ink to remove air in an ink path.

Additional features and utilities of the present general inventive concept will be set forth in part in the description which follows and, in part, will be obvious from the description, or may be learned by practice of the present general inventive concept.

Embodiments of the present general inventive concept provide an ink cartridge easily attached to and removed from an inkjet printer, the ink cartridge including a plurality of print heads ejecting ink, an ink channel unit supplying ink to the plurality of print heads, at least one filter unit filtering ink supplied to the ink channel unit, and at least one septum unit connecting the ink channel unit, at least one filter unit, and the inkjet printer.

The ink cartridge may be protected by being interposed between a lower case and an upper case. The plurality of print heads may be disposed on a lower surface of the ink channel unit and may be protected by being covered by a protective cover.

The ink channel unit may include a plurality of ink inlets to which different color inks flow, a plurality of ink outlets from which ink is discharged, a plurality of connection holes to supply ink to the plurality of print heads, and connection channels to connect the plurality of ink inlets, the plurality of ink outlets, and the plurality of connection holes.

The number of the plurality of ink inlets may be four, a pair of which is disposed on each of end parts of the ink channel unit, and the number of the plurality of ink outlets may be four, a pair of which is disposed on each end part of the ink channel unit.

The at least one filter unit may be disposed on an upper surface of the ink channel unit.

The number of the at least one filter unit may be two, each of which is disposed on each end part of the ink channel unit, and the two filter units may respectively include two channels that are separated from each other.

The plurality of channels may respectively include a filter and may be separated into a lower channel formed on the lower part of the filter and into an upper channel formed on the upper part of the filter.

The upper plate may include ink inlet ports connected to one end of the upper channel, to which ink may flow, and priming ports connected to the other end of the upper channel, from which ink, foreign substances, and air included in ink may be discharged.

The upper channel may include a ceiling wall, the ceiling wall being inclined to be higher at the priming ports than at the ink inlet ports.

The lower plate may include an ink outlet port connected to the lower channel for discharging ink, the ink outlet port being connected to the ink channel unit.

The at least one septum unit may include a structure in which a septum body, a seal assembly, a cover, a dual coupler, and a septum cartridge may be assembled.

The at least one septum unit may include three ports for each of different color inks, the three ports including ink supply ports, channel circulation ports, and priming circulation ports.

The number of the at least one septum unit may be two, of which are disposed, respectively, near to each end part of the ink channel unit, any one of the two septum units may include two ink supply ports and two channel circulation ports for two different color inks, and two channel circulation ports for two other different color inks, and the other one of the two septum units may include two channel circulation ports for two different color inks, and two ink supply ports and two priming circulation ports for two other different color inks.

The ink supply ports may be connected to the ink supply ports of the filter unit, the channel circulation ports may be connected to the ink outlets of the ink channel unit, and the priming circulation ports may be connected to the priming ports of the filter unit.

Embodiments of the present general inventive concept provide an ink circulation system of an inkjet printer, the system including the ink cartridge above, an ink tank storing ink to be supplied to the ink cartridge, at least one 3-way valve interposed between the ink cartridge and the ink tank to selectively control channel circulation and priming circulation, channel circulation circulating ink in the ink channel unit and priming circulation circulating ink in the at least one filter unit; and an ink pump interposed between the at least one 3-way valve and the ink tank to provide driving power for circulating ink.

The ink tank, the ink pump, and the at least one 3-way valve may be installed in the inkjet printer.

Each of the at least one 3-way valve may include channel circulation ports, priming circulation ports, and ink discharge ports, wherein the channel circulation ports connect the ink channel unit through the septum unit, the priming circulation ports connect the filter unit through the septum unit, and the ink discharge ports connect the ink pump.

The ink tank and the ink supply ports of the septum unit may include a negative pressure adjusting unit and a lock valve interposed therebetween, the lock valve may selectively prevent ink supplied to the ink cartridge from the ink tank.

Priming circulation may be performed when the ink pump is operated, the lock valve and the priming circulation ports of the at least one 3-way valve are opened, and the channel circulation ports of the at least one 3-way valve are closed. The ink may be supplied from the ink tank to the filter unit through the septum unit and may return to the ink tank through the septum unit, the priming circulation ports of the at least one 3-way valve, and the ink pump, during the priming circulation.

Channel circulation may be performed when the ink pump is operated, the lock valve and the channel circulation ports of the at least one 3-way valve are opened, and the priming circulation ports of the at least one 3-way valve are closed. The ink may be supplied from the ink tank to the ink channel unit and the plurality of print heads through the septum unit and the filter unit and may return to the ink tank through the septum unit, the channel circulation ports of the at least one 3-way valve, and the ink pump, during channel circulation.

A normal printing mode of the inkjet printer may be performed when the ink pump is in an operation-stop mode and the lock valve is opened.

The ink pump may be in an operation-stop mode and the lock valve may be closed, when operation of the inkjet printer is stopped.

Embodiments of the present general inventive concept also provide for an image forming apparatus, comprising an inkjet print unit; and a detachable ink cartridge, wherein the ink cartridge comprises at least one septum unit to separate and supply stored ink, at least one filter unit to filter out impurities from ink received from the at least one septum unit, a plurality of channel plates stacked upon each other defining a plurality of connection holes to allow ink received from the at least one filter unit to pass therethrough, and a plurality of print heads to eject ink received from the plurality of channel plates onto a printing medium.

Embodiments of the present general inventive concept also provide for an image forming apparatus capable of removing impurities and air flowing in the ink path of the image forming apparatus, comprising at least one detachable ink cartridge comprising at least one septum unit to separate and supply stored ink, at least one filter unit to filter out impurities from ink received from the at least one septum unit, a plurality of channel plates stacked upon each other defining a plurality of connection holes to allow ink received from the at least one filter unit to pass therethrough, and a plurality of print heads to eject ink received from the plurality of channel plates onto a printing medium, an ink tank to store ink to be supplied to the ink cartridge, and an ink pump to provide driving power to circulating ink.

### BRIEF DESCRIPTION OF THE DRAWINGS

The above and other features and advantages of the present general inventive concept will become more apparent by describing in detail exemplary embodiments thereof with reference to the attached drawings in which:

FIG. 1 is an exploded perspective view of an ink cartridge according to an exemplary embodiment of the present general inventive concept;

FIG. 2 is an exploded perspective view of a plurality of print heads included in the ink cartridge of FIG. 1;

FIG. 3 is an exploded perspective view of an ink channel unit included in the ink cartridge of FIG. 1;

FIG. 4 is a plane view of a filter unit included in the ink cartridge of FIG. 1;

FIG. 5 is a cross-sectional diagram of the filter unit of FIG. 4 taken along the line A-A′ of FIG. 4;

FIG. 6 is an exploded perspective view of a septum unit included in the ink cartridge of FIG. 1;

FIG. 7 is a perspective view of a left septum unit included in the ink cartridge of FIG. 1;

FIG. 8 is a perspective view of a right septum unit included in the ink cartridge of FIG. 1;

FIG. 9 illustrates an ink circulation system according to an exemplary embodiment of the present general inventive concept;

FIG. 10 is a perspective view of an ink tank, a 3-way valve, an ink pump, and a negative pressure adjusting unit included in the ink circulation system of FIG. 9; and

FIG. 11 illustrates an image forming apparatus according to an exemplary embodiment of the present general inventive concept including a printing medium printing path.

### DETAILED DESCRIPTION OF THE EXEMPLARY EMBODIMENTS

The present general inventive concept will now be described more fully with reference to the accompanying drawings, in which exemplary embodiments of the present general inventive concept are illustrated. The exemplary embodiments are provided so that this disclosure will be thorough and complete, and will fully convey the scope of the invention to those skilled in the art. In the drawings, like reference numerals in the drawings denote like elements and a size of elements are exaggerated for clarity.

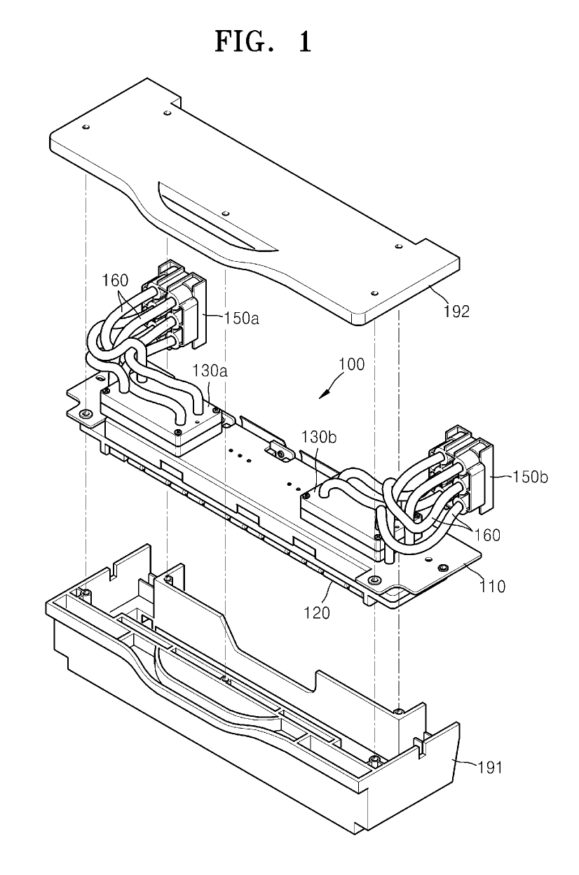

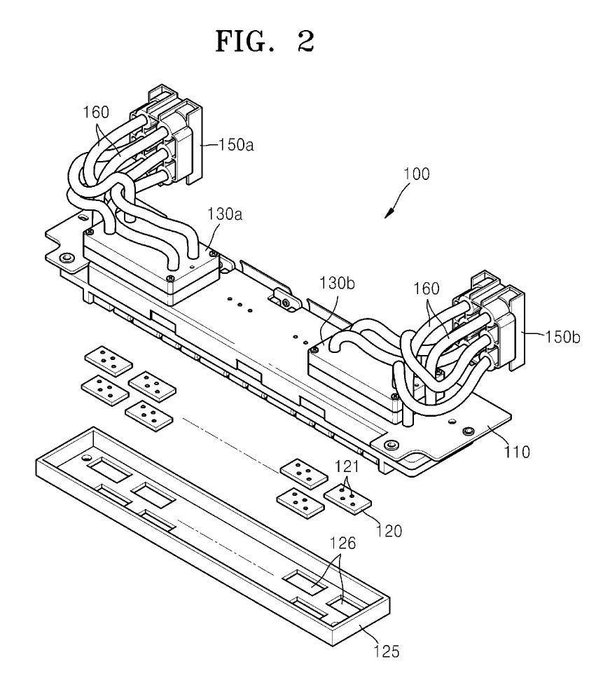

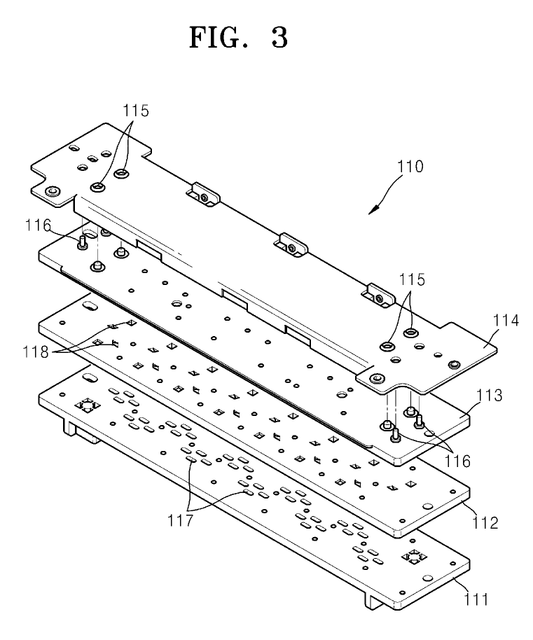

FIG. 1 is an exploded perspective view of an ink cartridge 100 according to an exemplary embodiment of the present general inventive concept; FIG. 2 is an exploded perspective view of a plurality of print heads 120 included in the ink cartridge 100; and FIG. 3 is an exploded perspective view of an ink channel unit 110 included in the ink cartridge 100.

Referring to FIGS. 1 through 3, the ink cartridge 100 may be easily removed from and attached to a multi-array head type inkjet printer. The ink cartridge 100 may include the plurality of print heads 120, the ink channel unit 110, left and right filter units 130A and 130B, left and right septum units 150A and 150B, wherein the plurality of print heads 120 may eject ink onto a printing medium, the ink channel unit 110 may include channels formed therein to supply ink to the plurality of print heads 120, the left and right filter units 130A and 130B filter ink may be supplied to the ink channel unit 110, and the left and right septum units 150A and 150B may connect the ink channel unit 110, the left and right filter units 130A and 130B, and the inkjet printer. The ink cartridge 100 may be interposed between a lower case 191 and an upper case 192 so as to be protected.

As illustrated in FIG. 2, the plurality of print heads 120 may be arranged in two rows on a lower surface of the ink channel unit 110. A plurality of ink inlets 121 are formed on a upper surface of each of the print heads 120 and a plurality of nozzles (not illustrated) to eject ink are formed on a lower surface of each of the print heads 120. Different color inks flow into each of the print heads 120 respectively through the plurality of ink inlets 121 and ink flowed into each of the print heads 120 may be ejected through the plurality of nozzles.

The plurality of print heads 120 may be protected by being covered by a protective cover 125, and a plurality of openings 126 to expose the nozzles formed on the lower surfaces of the plurality of print heads 120 may be formed on the protective cover 125.

As illustrated in FIG. 3, the ink channel unit 110 may be formed of a plurality of stacked channel plates 111, 112, 113, and 114. For example, the ink channel unit 110 may be manufactured by sequentially stacking and combining four channel plates, that is, the first channel plate 111, the second channel plate 112, the third channel plate 113, and the fourth channel plate 114.

The ink channel unit 110 may include four ink inlets 115, four ink outlets 116, and a plurality of connection holes 117. The ink inlets 115, the ink outlets 116, and the connection holes 117 may be connected to each other by connection channels 118. Different color inks may flow into the ink channel unit 110 through the four ink inlets 115 and may be discharged through the four ink outlets 116. The plurality of connection holes 117 are respectively connected to the plurality of ink inlets 121 formed on the print heads 120. A pair of ink inlets 115 may be disposed on each of end parts of the ink channel unit 110 and a pair ink outlets 116 may be disposed on each end part of the ink channel unit 110.

The left and right filter units 130A and 130B may be attached to the upper surface of the ink channel unit 110 and the filter units 130A and 130B may be arranged on each end part of the ink channel unit 110.

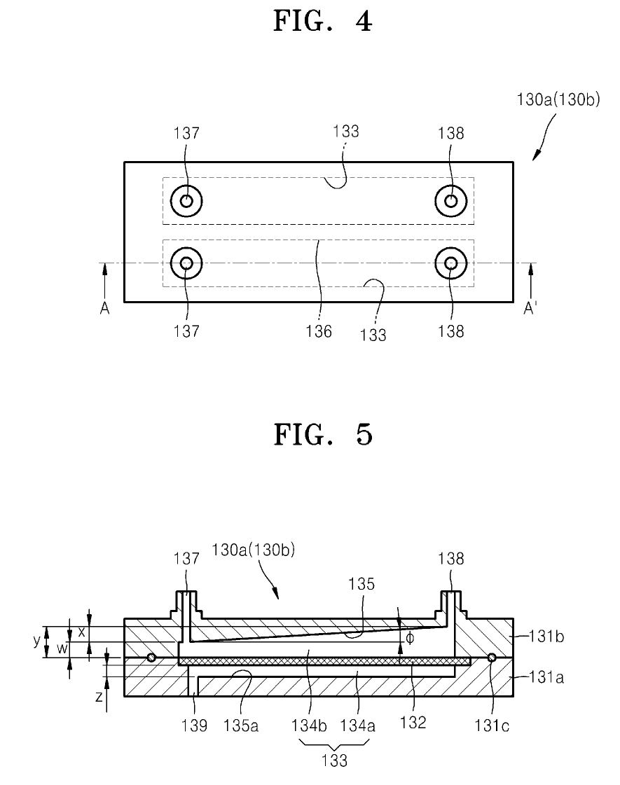

FIG. 4 is a plane view of the left filter unit 130A or right filter unit 130B included in the ink cartridge 100 of FIG. 1 and FIG. 5 is a cross-sectional diagram of the left filter unit 130A or right filter unit 130B of FIG. 4 taken along the line A-A′ of FIG. 4. The left filter unit 130A and the right filter unit 130B illustrated in FIG. 1 have the same structure and the difference is only in position.

Referring to FIGS. 4 and 5, the left and right filter units 130A and 130B are respectively formed of a lower plate 131A and an upper plate 131B. The lower plate 131A and the upper plate 131B may be connected to each other using a seal 131C interposed between the lower plate 131A and the upper plate 131B. Two channels 133 may be formed between the lower plate 131A and the upper plate 131B and may be separated from each other by a partition wall 136. Filters 132 are respectively formed in the two channels 133 and the two channels 133 may each be separated into a lower channel 134A formed on the lower part of the filter 132 and an upper channel 134B formed on the upper part of the filter 132.

Ink inlet ports 137, to which ink flows, may be respectively connected to one end of the two channels 133, and priming ports 138 for discharging ink, foreign substances, and air included in ink may connect to the other end of the two channels 133. The ink inlet ports 137 and the priming ports 138 are formed to vertically penetrate the upper plate 131B and are connected to the upper channel 134B. A ceiling wall 135 of the upper channel 134B may be inclined at an angle φ to be higher at the priming ports 138 than at the ink inlet ports 137 so that air contained in ink is easily removed during a priming circulation process, which will be described later, through the priming ports 138. Also, the ceiling wall 135 may vertically rise by a distance X.

Further, the distance from filters 132 to the lowest point of the ceiling wall is labeled as W in FIG. 5. Also, the distance from filters 132 to the highest point of the ceiling wall is labeled as Y. Additionally, the distance from filters 132 to a bottom wall 135a of lower channel 134a is labeled Z in FIG. 5.

The lower plate 131A may include an ink outlet port 139 to discharge ink and the ink outlet port 139 is connected to the lower channel 134A. The ink outlet port 139 is connected to the ink inlets 115 of the ink channel unit 110.

In the filter units 130A and 130B, ink flowed into the upper channel 134B through the ink inlet ports 137 may be filtered using the filter 132. Ink flowed into the lower channel 134A through the filter 132 may be discharged through the ink outlet port 139. Then, ink is flowed into the ink channel unit 110 through the ink inlets 115 of the ink channel unit 110. Ink in the upper channel 134B disposed above the filter 132 may be discharged with the air contained in ink during the priming circulation process, which will be described later.

As described above, two filter units 130A and 130B may be disposed in the ink cartridge 100. However, the exemplary embodiment of the present general inventive concept is not limited thereto and only one filter unit may be disposed. In this case, four channels separated by a partition wall are formed in the filter unit, and ink inlet ports and priming ports may be respectively connected to both ends of the channels. That is, four channels, through which different color inks pass, four ink inlet ports, four priming ports, and four ink outlet ports may be disposed on one filter unit.

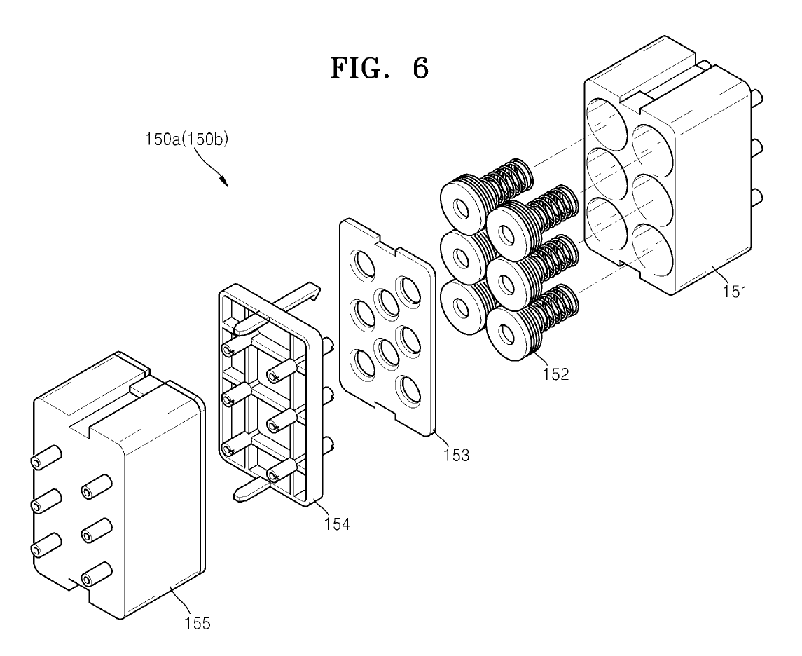

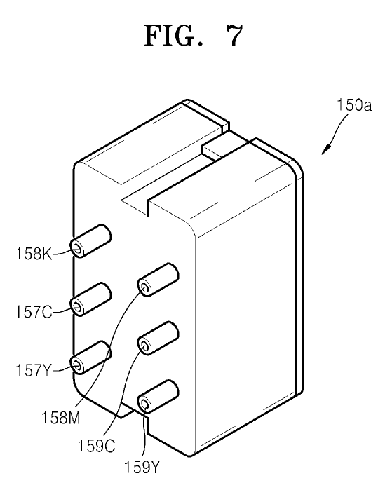

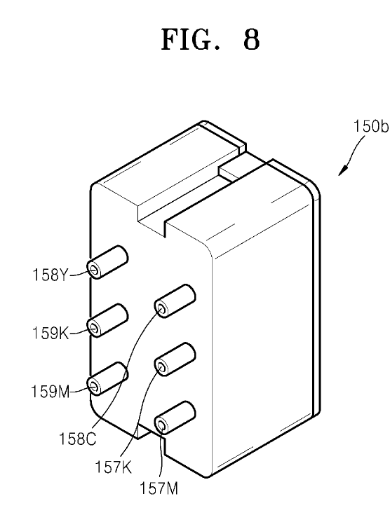

FIG. 6 is an exploded perspective view of the left or right septum unit 150A or 150B included in the ink cartridge 100 of FIG. 1; FIG. 7 is a perspective view of the left septum unit 150A included in the ink cartridge 100 of FIG. 1; and FIG. 8 is a perspective view of the right septum unit 150B included in the ink cartridge 100 of FIG. 1.

Referring to FIG. 6, the left or right septum unit 150A or 150B may have a structure in which a septum body 151, a seal assembly 152, a cover 153, a dual coupler 154, and a septum cartridge 155 are assembled.

Referring to FIGS. 7 and 8, the left and right septum units 150A and 150B respectively include six ports. That is, twelve ports are disposed on the left and right septum units 150A and 150B. Three ports may be disposed for each of four different color inks and the three ports may include ink supply ports 157Y, 157M, 157C, and 157K, channel circulation ports 158Y, 158M, 158C, and 158K, and priming circulation ports 159Y, 159M, 159C, and 159K. For example, the ink supply port 157C and the priming circulation ports 159C for cyan C ink, the ink supply port 157Y and the priming circulation port 159Y for yellow Y ink, the channel circulation port 158K for black K ink, and the channel circulation port 158M for magenta M ink from among four different color inks, for example, yellow Y, magenta M, cyan C, and black K, may be disposed on the left septum unit 150A. Also, the ink supply port 157K and the priming circulation port 159K for black K ink, the ink supply port 157M and the priming circulation port 159M for magenta M ink, the channel circulation port 158C for cyan C ink, and the channel circulation port 158Y for yellow Y ink may be disposed on the right septum unit 150B.

The twelve ports may be respectively connected to four ink inlet ports 137 and four priming ports 138 disposed on the left and right filter units 130A and 130B illustrated in FIGS. 4 and 5, and four ink outlets 116 disposed on the ink channel unit 110 illustrated in FIG. 3. More specifically, the ink supply ports 157Y and 157C disposed on the left septum unit 150A are respectively connected to two ink inlet ports 137 included in the left filter unit 130A. The ink supply ports 157K and 157M disposed on the right septum unit 150B are respectively connected to two ink inlet ports 137 included in the right filter unit 130B. The priming circulation ports 159Y and 159C disposed on the left septum unit 150A may be respectively connected to two priming ports 138 included in the left filter unit 130A. The priming circulation ports 159K and 159M disposed on the right septum unit 150B may be respectively connected to two priming ports 138 included in the right filter unit 130B. Also, the channel circulation ports 158K and 158M disposed on the left septum unit 150A may be respectively connected to two ink outlets 116 disposed on left end parts of the ink channel unit 110. The channel circulation ports 158Y and 158C disposed on the right septum unit 150B may be respectively connected to two ink outlets 116 disposed on right end parts of the ink channel unit 110. The twelve ports may be respectively connected to four ink inlet ports 137, four priming ports 138, and four ink outlets 116 through tubes 160, as illustrated in FIGS. 1 and 2.

As described above, when only one filter unit is disposed in the ink cartridge 100, only one septum unit may be included. In this case, twelve ports may be disposed on one septum unit.

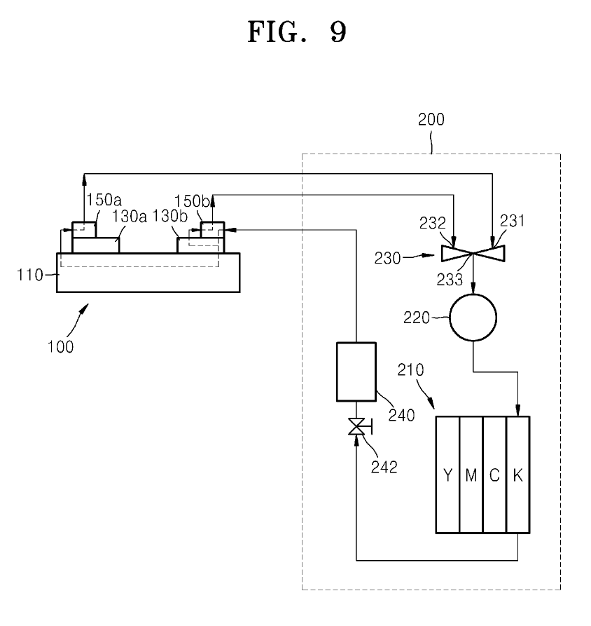

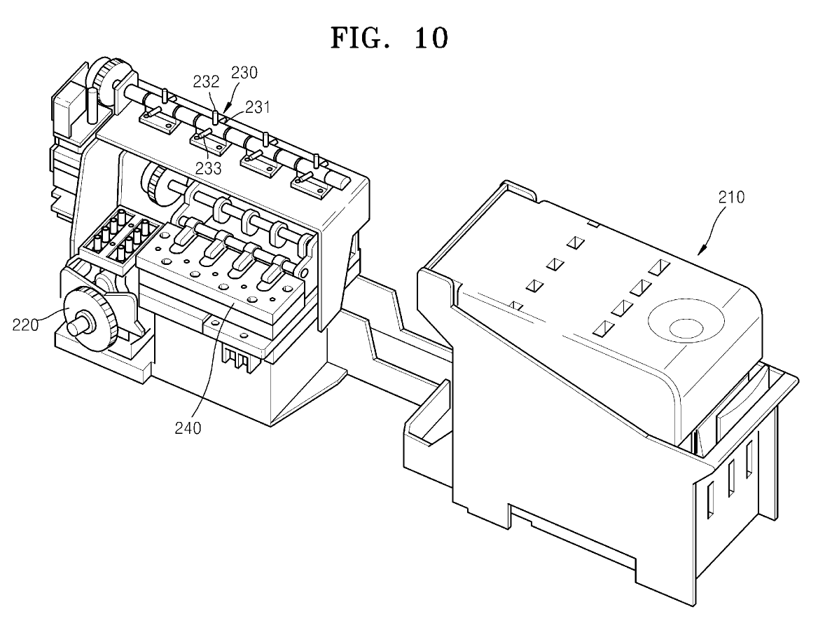

FIG. 9 illustrates an ink circulation system according to an exemplary embodiment of the present general inventive concept and FIG. 10 is a perspective view of an ink tank 210, a 3-way valve 230, an ink pump 220, and a negative pressure adjusting unit 240 included in the ink circulation system of FIG. 9.

Referring to FIGS. 9 and 10, the ink circulation system may include the ink cartridge 100 and the 3-way valve 230 interposed between the ink cartridge 100 and the ink tank 210 to selectively control channel circulation and priming circulation of ink. As illustrated in FIG. 10, there is one 3-way valve 230 for each ink having different color for the four different color inks and the four 3-way valves 230 may be installed in an inkjet printer 200. The four 3-way valves 230 respectively include three ports, that is, channel circulation ports 231, priming circulation ports 232, and ink discharge ports 233. Four channel circulation ports 231 included in the four 3-way valves 230 may be respectively connected to the channel circulation ports 158Y, 158M, 158C, and 158K of the left and right septum units 150A and 150B, as illustrated in FIGS. 7 and 8. For example, the channel circulation port 231 of the 3-way valve 230 for black K ink is connected to the channel circulation port 158K of the left septum unit 150A, as illustrated in FIG. 7. Four priming circulation ports 232 included in the four 3-way valves 230 may be respectively connected to the priming circulation ports 159Y, 159M, 159C, and 159K of the left and right septum units 150A and 150B, as illustrated in FIGS. 7 and 8. For example, the priming circulation port 232 of the 3-way valve 230 for black K ink is connected to the priming circulation port 159K of the right septum unit 150B, as illustrated in FIG. 8. Also, four ink discharge ports 233 disposed in the four 3-way valves 230 are connected to the ink tank 210 through the ink pump 220 providing driving power for ink circulation as illustrated in FIG. 9.

The ink tank 210 may be installed in the inkjet printer 200 and may store four color inks, for example, yellow Y, magenta M, cyan C, and black K. Ink having four different colors stored in the ink tank 210 is respectively connected to the four 3-way valves 230. Also, ink having four different colors stored in the ink tank 210 is respectively connected to the ink supply ports 157Y, 157M, 157C, and 157K of the left and right septum units 150A and 150B, as illustrated in FIGS. 7 and 8.

The negative pressure adjusting unit 240 may be interposed between the ink tank 210 and the ink supply ports 157Y, 157M, 157C, and 157K of the left and right septum units 150A and 150B. The negative pressure adjusting unit 240 may be installed in the inkjet printer 200 and may form the negative pressure in an ink path, thereby preventing leakage of ink. Also, a lock valve 242 may be installed between the negative pressure adjusting unit 240 and the ink tank 210 and may selectively block ink supplied from the ink tank 210 to the ink cartridge 100.

Hereinafter, a circulation path of, for example, black K ink, is described in detail with reference to FIG. 9 and Table 1 below. Circulation paths of ink having other colors are the same as described below.

TABLE 1

| | | | | Channel | Priming |
|---|---|---|---|---|---|
| | | | Lock | circulation | circulation |
| Mode | | Ink pump | valve | ports | ports |
| Initialization | Priming | In operation | Opened | Closed | Opened |
| | circulation | | | | |
| | Channel | In operation | Opened | Opened | Closed |
| | circulation | | | | |

| | | | | |
|---|---|---|---|---|
| Printing | Stop | Opened | Opened | Closed |
| Operation stop | Stop | Closed | Opened | Closed |

Referring to FIG. 9 and table 1, when the ink cartridge 100 is firstly installed to the inkjet printer 200, an initialization mode may be performed. The initialization mode may be formed of a priming circulation and a channel circulation.

In the priming circulation, ink is circulated in the filter units 130A and 130B, air in channels 133 of the filter units 130A and 130B is removed, and ink is filled in the channels 133. Here, the ink pump 220 is in an operation mode, the lock valve 242 and the priming circulation ports 232 of the 3-way valves 230 are opened, and the channel circulation ports 231 of the 3-way valves 230 are closed. Black K ink is flowed into the channel 133 of the right filter unit 130B through the ink supply ports 157K of the right septum unit 150B and the ink inlet ports 137 of the right filter unit 130B from the ink tank 210. Then, black K ink may fully fill the channels 133 and push air out from the channels 133 through the priming ports 138.

Black K ink fully filled in the channels 133 may be discharged through the priming ports 138 and discharged black K ink passes through the priming circulation port 159K of the right septum unit 150B, the priming circulation ports 232 of the 3-way valves 230, and the ink pump 220 so that the black K ink returns to the ink tank 210.

In the channel circulation, ink may be circulated in the ink channel unit 110 and air in the ink channel unit 110 may be removed while ink fills the channel of the ink channel unit 110. Here, the ink pump 220 is in an operation mode, the lock valve 242 and the channel circulation ports 231 of the 3-way valves 230 are opened, and the priming circulation ports 232 of the 3-way valves 230 are closed. Black K ink is flowed into the channel 133 of the right filter unit 130B through the ink supply ports 157K of the right septum unit 150B and the ink inlet ports 137 of the right filter unit 130B from the ink tank 210. Then, black K ink passes through the filter 132 of the right filter unit 130B and may flow into the ink channel unit 110 through the ink outlet port 139 and the ink inlets 115 of the ink channel unit 110. Black K ink flowed into the connection channels 118 of the ink channel unit 110 may fully fill the connection channels 118 and push air in the connection channels 118 out through the ink outlets 116. Here, black K ink also may fill the plurality of print heads 120 through the connection holes 117 of the ink channel unit 110 and the plurality of ink inlets formed on the print heads 120. When the connection channels 118 are fully filled by black K ink, black K ink is discharged through ink outlets 116 and discharged black K ink passes through the channel circulation port 158K of the left septum unit 150A, the channel circulation ports 231 of the 3-way valves 230, and the ink pump 220 so that the black K ink returns to the ink tank 210.

In a normal printing mode performed after the initialization mode, ink may be discharged through the plurality of print heads 120 so as to perform a printing process. Here, the ink pump 220 is in an operation-stop mode and the lock valve 242 is opened. In this case, since the ink pump 220 is stopped, the priming circulation and the channel circulation are not performed. However, the channel circulation ports 231 of the 3-way valves 230 may remain open and the priming circulation ports 232 of the 3-way valves 230 may remain close. Ink in the plurality of print heads 120 is ejected onto a printing medium through the nozzles (not illustrate) and the plurality of print heads 120 may be refilled by an amount of ejected ink from the ink tank 210. A process of refilling ink is the same as a process of supplying black K ink to the print heads 120 through the right septum unit 150, the right filter unit 130B, and the ink channel unit 110. However, ink does not return to the ink tank 210 through the 3-way valves 230.

In an operation-stop mode of the inkjet printer performed after the normal printing mode is completed, the ink pump 220 may be stopped and the lock valve 242 closed. The channel circulation ports 231 of the 3-way valves 230 may remain open and the priming circulation ports 232 of the 3-way valves 230 may remain close.

The priming circulation and the channel circulation in the initialization mode are described above. However, the priming circulation and the channel circulation may be performed after the initialization mode. For example, the channel circulation may be firstly performed before starting the normal printing mode or the operation-stop mode. Also, air may be flowed into the ink path through the tubes 160 due to long periods of use and non-use and may be collected in the upper channel 134B of the filter units 130A and 130B. In this case, the periodic priming circulation may be performed to remove air in the filter units 130A and 130B.

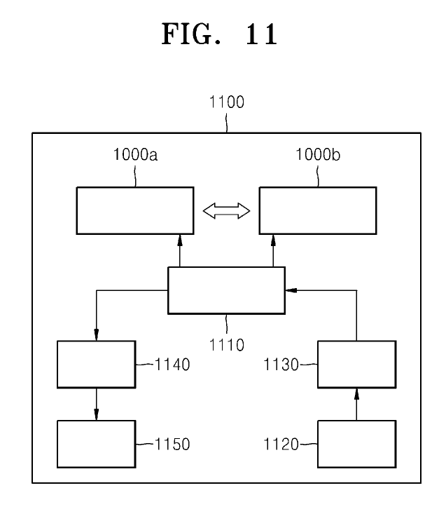

FIG. 11 illustrates an image forming apparatus 1100 of an exemplary embodiment of the present general inventive concept. Furthermore, an inkjet print unit 1000b as well as an ink cartridge 1000a are illustrated. Additionally, a printing medium feeding path is illustrated in FIG. 11, wherein a pickup and feeding unit 1130 obtains printing media from a printing medium housing 1120. A controller 1110 interacts with the inkjet print unit 1000a and ink cartridge 1000a when the printing medium is printed upon, and then the printing medium is discharged by a discharge unit 1140 into a printing medium discharge housing 1150. The inkjet print unit 1000b and the ink cartridge 1000a are similar to or the same as the inkjet printer 200 and the ink cartridge 100 of FIGS. 1-10.

As described above, in the ink cartridge and the ink circulation system according to the present general inventive concept, the filter units are installed in the ink cartridge so that foreign substances or air can be prevented from flowing into the ink channel unit when the ink cartridge is attached to or removed from the inkjet printer. Also, since the filter units may be disposed on the upper surface of the ink channel unit included in the ink cartridge, the size is not limited as compared with the prior art, in which the filter units are installed in the inkjet printer, and thus an area of the filter units may increase, thereby preventing pressure drop in the filter units that may occur due to increase in an amount of flowing ink. In addition, the 3-way valves are used to selectively perform channel circulation and priming circulation, if needed, and thus air in the filter units and the ink channel unit may be removed when the ink cartridge is firstly installed in the inkjet printer or later. Thus, stable negative pressure may be maintained in the plurality of print heads. Moreover, when the ink cartridges are distributed, fillers such as ink may not be filled in an ink path and thus manufacturing cost of the ink cartridges may be reduced.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. An ink cartridge easily attached to and removed from an inkjet printer, the ink cartridge comprising:
a plurality of print heads to eject ink;
an ink channel unit to supply ink to the plurality of print heads;
at least one filter unit to filter ink supplied to the ink channel unit; and
at least one septum unit to connect the ink channel unit, at least one filter unit, and the inkjet printer.

2. The ink cartridge of claim 1, wherein the ink cartridge is protected by being interposed between a lower case and an upper case.

3. The ink cartridge of claim 1, wherein the plurality of print heads are disposed on a lower surface of the ink channel unit and are protected by being covered by a protective cover.

4. The ink cartridge of claim 1, wherein the ink channel unit comprises:
a plurality of ink inlets to which different color inks flow, a plurality of ink outlets from which ink is discharged, a plurality of connection holes supplying ink to the plurality of print heads, and connection channels connecting the plurality of ink inlets, the plurality of ink outlets, and the plurality of connection holes.

5. The ink cartridge of claim 4, wherein the number of the plurality of ink inlets is four, a pair of which is disposed on each of end parts of the ink channel unit, and the number of the plurality of ink outlets is four, a pair of which is disposed on each end part of the ink channel unit.

6. The ink cartridge of claim 1, wherein the at least one filter unit is disposed on an upper surface of the ink channel unit.

7. The ink cartridge of claim 1, wherein the number of the at least one filter unit is two, each of which is disposed on each end part of the ink channel unit, and the two filter units respectively comprise two channels that are separated from each other.

8. The ink cartridge of claim 1, wherein the at least one filter unit is formed of a lower plate and an upper plate, the lower plate and the upper plate comprising:
a plurality of channels interposed therebetween and separated from each other by a partition wall.

9. The ink cartridge of claim 8, wherein the plurality of channels respectively comprise:
a filter and are separated into a lower channel formed on the lower part of the filter and into an upper channel formed on the upper part of the filter.

10. The ink cartridge of claim 9, wherein the upper plate comprises:
ink inlet ports connected to one end of the upper channel, to which ink is flowed, and priming ports connected to the other end of the upper channel, from which ink, foreign substances, and air included in ink are discharged.

11. The ink cartridge of claim 9, wherein the upper channel comprises:
a ceiling wall, the ceiling wall being inclined to be higher at the priming ports than at the ink inlet ports.

12. The ink cartridge of claim 9, wherein the lower plate comprises:
an ink outlet port connected to the lower channel for discharging ink, the ink outlet port being connected to the ink channel unit.

13. The ink cartridge of claim 1, wherein the at least one septum unit comprises:
a structure in which a septum body, a seal assembly, a cover, a dual coupler, and a septum cartridge are assembled.

14. The ink cartridge of claim 1, wherein the at least one septum unit comprises:
three ports for each of different color inks, the three ports comprising ink supply ports, channel circulation ports, and priming circulation ports.

15. The ink cartridge of claim 14, wherein the number of the at least one septum unit is two, of which are disposed, respectively, near to each end part of the ink channel unit, any one of the two septum units comprises:
two ink supply ports and two channel circulation ports for two different color inks, and two channel circulation ports for two other different color inks, and the other one of the two septum units comprises:
two channel circulation ports for two different color inks, and two ink supply ports and two priming circulation ports for two other different color inks.

16. The ink cartridge of claim 15, wherein the ink supply ports are connected to the ink supply ports of the filter unit, the channel circulation ports are connected to the ink outlets of the ink channel unit, and the priming circulation ports are connected to the priming ports of the filter unit.

17. An ink circulation system of an inkjet printer, the system comprising:
an ink cartridge comprising:
a plurality of print heads to eject ink;
an ink channel unit to supply ink to the plurality of print heads;
at least one filter unit to filter ink supplied to the ink channel unit; and
at least one septum unit to connect the ink channel unit, at least one filter unit, and the inkjet printer;
an ink tank storing ink to be supplied to the ink cartridge;
at least one 3-way valve interposed between the ink cartridge and the ink tank to selectively control channel circulation and priming circulation, the channel circulation circulating ink in the ink channel unit and the priming circulation circulating ink in the at least one filter unit; and
an ink pump interposed between the at least one 3-way valve and the ink tank to provide driving power to circulating ink.

18. The system of claim 17, wherein the ink tank, the ink pump, and the at least one 3-way valve are installed in the inkjet printer.

19. The system of claim 17, wherein each of the at least one 3-way valve comprises:
channel circulation ports, priming circulation ports, and ink discharge ports, the channel circulation ports connecting to the ink channel unit through the septum unit, the priming circulation ports connecting to the filter unit through the septum unit, and the ink discharge ports connecting to the ink pump.

20. The system of claim 19, wherein the ink tank and ink supply ports of the septum unit comprise:
a negative pressure adjusting unit and a lock valve interposed therebetween, the lock valve selectively preventing ink supplied to the ink cartridge from the ink tank.

21. The system of claim 20, wherein the priming circulation is performed when the ink pump is operated, the lock valve and the priming circulation ports of the at least one 3-way valve are opened, and the channel circulation ports of the at least one 3-way valve are closed.

22. The system of claim 21, wherein the ink is supplied from the ink tank to the filter unit through the septum unit and returns to the ink tank through the septum unit, the priming circulation ports of the at least one 3-way valve, and the ink pump, during the priming circulation.

23. The system of claim 20, wherein the channel circulation is performed when the ink pump is operated, the lock valve and the channel circulation ports of the at least one 3-way valve are opened, and the priming circulation ports of the at least one 3-way valve are closed.

24. The system of claim 23, wherein the ink is supplied from the ink tank to the ink channel unit and the plurality of print heads through the septum unit and the filter unit and returns to the ink tank through the septum unit, the channel circulation ports of the at least one 3-way valve, and the ink pump, during the channel circulation.

25. The system of claim 20, wherein a normal printing mode of the inkjet printer is performed when the ink pump is in an operation-stop mode and the lock valve is opened.

26. The system of claim 20, wherein the ink pump is in an operation-stop mode and the lock valve is closed, when operation of the inkjet printer is stopped.

27. An image forming apparatus, comprising
an inkjet print unit; and
a detachable ink cartridge, wherein the ink cartridge comprises:
at least one septum unit to separate and supply stored ink;
at least one filter unit to filter out impurities from ink received from the at least one septum unit;
a plurality of channel plates stacked upon each other defining a plurality of connection holes to allow ink received from the at least one filter unit to pass therethrough; and
a plurality of print heads to eject ink received from the plurality of channel plates onto a printing medium.
